(19) United States
(12) Patent Application Publication
(10) Pub. No.: US 2020/0195741 A1
(43) Pub. Date: Jun. 18, 2020

(54) GENERATING CONTINUOUS STREAMS OF DATA FOR COMPUTING DEVICES

(71) Applicant: International Business Machines Corporation, Armonk, NY (US)

(72) Inventors: Al CHAKRA, Apex, NC (US); Jenny S. LI, Cary, NC (US); Yu DENG, Yorktown Heights, NY (US)

(21) Appl. No.: 16/217,976

(22) Filed: Dec. 12, 2018

(51) Int. Cl. H04L 29/08; G06N 5/04

(52) U.S. Cl. CPC H04L 67/2804; H04L 67/18; G06N 5/048

(57) ABSTRACT

Certain aspects of the present disclosure provide techniques for identifying gaps in streaming data representative of data associated with a sensor in a first computing device and filling in the gaps in the data from computing devices of other users to generate a continuous stream of data. An example technique includes receiving a stream of data associated with a sensor in a first computing device and identifying data segments expected in the streaming data are missing. To fill in the gaps identified, proxy data is retrieved, such as live streaming data from a sensor in a second computer device, previously collected data, and data from a predictive model. Based on the proxy data, estimated data is generated to fill in the gaps identified and augment the stream of data to generate a continuous data stream.

### BACKGROUND

The present invention relates to a data stream from a physical sensor, and more specifically, to filling gaps in a data stream collected by a sensor using data from other sensors to generate a continuous stream of data.

A variety of computing and electronic devices, which are often referred to as Internet of things (IoT), include sensors that collect data. In one example, sensors in weather radar devices can collect temperature data, air pressure data, and wind speed data from the surrounding environment. In another example, sensors in computing devices can collect physiological data. Further, sensors integrated in IoT collect data as specified by the configuration of the respective sensor. Once data is collected by sensors in such devices, the data can be streamed to a remote server.

The widespread use of such devices has created monitoring dependencies. Decisions based on data streamed from a computing device rely on the sensors in computing devices to collect and transmit accurate data. However, data collected from such devices is frequently inaccurate or simply incomplete. In some cases, the devices are battery powered and fail to collect data when the battery dies or is not charged. Further, the devices need to be “on” as well as configured and used properly in order to collect a continuous data stream that is complete and accurate. Otherwise, the sensors in a device can collect inaccurate data or incomplete data. As a result, decisions based on such data may lead to unintended or unwanted consequences.

### SUMMARY

According to one embodiment of the present invention, a method, system, and computer program product for generating a continuous data stream, the method comprising: receiving a stream of data associated with a first user, wherein the stream of data includes: a metric, and a time stamp indicating when the metric is recorded; identifying an expected data segment is missing from the stream of data; retrieving at least one type of proxy data; generating estimated data based on the at least one type of proxy data; and augmenting the stream of data with the estimated data to generate a continuous data stream.

The following description and the related drawing set forth in detail certain illustrative features of one or more embodiments.

### BRIEF DESCRIPTION OF THE SEVERAL VIEWS OF THE DRAWINGS

The appended figures depict certain aspects of the one or more embodiments and are therefore not to be considered limiting the scope of this disclosure.

FIG. 1 depicts a computing environment for generating a continuous data stream, according to one embodiment of the present disclosure.

FIG. 2 depicts a computing device capable of collecting sensor data, according to one embodiment of the present disclosure.

FIG. 3 depicts a view of a server identifying an expected data segment is missing from the streaming data and generating estimated data based on proxy data retrieved from other computing devices to fill in the gaps of missing data, according to one embodiment of the present disclosure.

FIG. 4 depicts a method for augmenting the streaming data with estimated data to generate a continuous data stream, according to one embodiment of the present disclosure.

FIG. 5 depicts a method for determining which type of proxy data to retrieve for generating estimated data, according to one embodiment of the present disclosure.

FIG. 6 depicts a method for identifying gaps in streaming data, generating estimated data to fill in the gaps, and augmenting the streaming data with the estimated data to generate a continuous data stream, according to one embodiment of the present disclosure.

FIG. 7 depicts a block diagram of a computing device, according to one embodiment of the present disclosure.

FIG. 8 depicts a block diagram of a server, according to one embodiment of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide methods, processing systems, and computer program products which can provide a more complete record regarding a monitored metric captured by a sensor. In some cases, the sensor is in a computing device. For example, a server application can identify gaps in data collected from a sensor in a computing device in which expected data is missing. Instead of leaving the gaps in the data collected by the sensor, the server application can fill in such gaps with estimated data generated using proxy data retrieved from a variety of sources. The server application generates a continuous data stream by filling in the gaps with estimated data. Doing so helps to provide a more complete record of the stream of sensor data. In some cases, therefore, the continuous data stream can be used to improve the quality of decisions that rely on data streams captured by sensors in computing devices.

Some embodiments are described using wearable devices as an example of computing devices. The wearable devices, which include sensors, collect sensor data and transmit the sensor data to a remote server. The remote server identifies a gap in the sensor data and uses senor data from various sources to generate estimated data and fill in the gaps in the sensor data to generate and publish a complete and accurate data stream. One of ordinary skill in the art will understand that embodiments of the invention is not limited to wearable devices and can be adapted to generate and fill in data for a variety of computing and electronic devices that collect data.

In one embodiment, a server receiving streaming data from a wearable device identifies data segments expected in the streaming data are missing. In some cases, the server can determine the data stream stopped unexpectedly. For example, assume an individual wears a wearable device everyday but forgets to wear the wearable device one day when hiking. In turn, the device fails to collect data about that individual when the individual is hiking. To fill in such gaps, the server borrows different types of proxy data to generate estimated data and ultimately, determine data about the individual without the individual wearing the device. In some cases, the server can retrieve live streaming data from a parallel person. A parallel person is user identified by the server and designated as such because the user is performing the same activity expected of the individual and shares one or more physical characteristics with the individual, such as height, weight, age, or gender. For example, a user and the individual can both be hiking in the same location at the same time, and the user and the individual can both be of the same gender and within the same height, weight, or age range. In this example, the server designates the user as a parallel person and retrieves live streaming data from the wearable device worn by the user (e.g., parallel person). Depending on the number of physical characteristics in common between the individual and the parallel person, the live streaming data from the parallel person is adjusted according to each of the physical characteristics of the individual to generate estimated data.

In other cases, the server retrieves live streaming data from one or more users performing the same or similar activity as the individual without designating the one or more users as a parallel person. In such cases, the server determines one or more users performing the same or similar activity as the individual but not sharing a physical characteristic in common with the individual. For example, the server can identify and retrieve live streaming data from a wearable device worn by two users hiking in close proximity to the individual with no physical characteristics in common with the individual. In this example, the server adjusts the live streaming data retrieved from the two users based on the profile data of the individual to generate estimated data. In still other cases, the server can retrieve previously collected data about the individual, other users, or both to use for generating estimated data. Generally, the server retrieves as much proxy data as is available. For example, if live streaming data and data from a predictive model are available, the server can retrieve both types of proxy data. In another example, the server can retrieve only previously collected data if no other type of proxy data is available.

The server may generate estimated data using the proxy data and physical characteristics of the individual (e.g., age, gender, weight, height). The estimated data predicts what the missing gaps of data would have been in the streaming data collected from the wearable device had those gaps not existed. For example, using live streaming data (e.g., from a user or a parallel person) and each physical characteristic of the individual, the server can estimate the metric of the individual that is missing from the streaming data (e.g., distance walked, calories burned). The server generates a continuous data stream by filling in the gaps of the streaming data with the estimated data. In some cases, the server may publish the continuous data stream to a subscriber authorized to view and access the data. In one example, the server can publish the continuous data stream to a medical professional, coach, trainer, or the individual. In another example, the server can allow authorized subscribers access to the continuous data stream. Further still, the continuous data stream can be used identify activity trends of the individual or to improve the quality of decisions made about the individual.

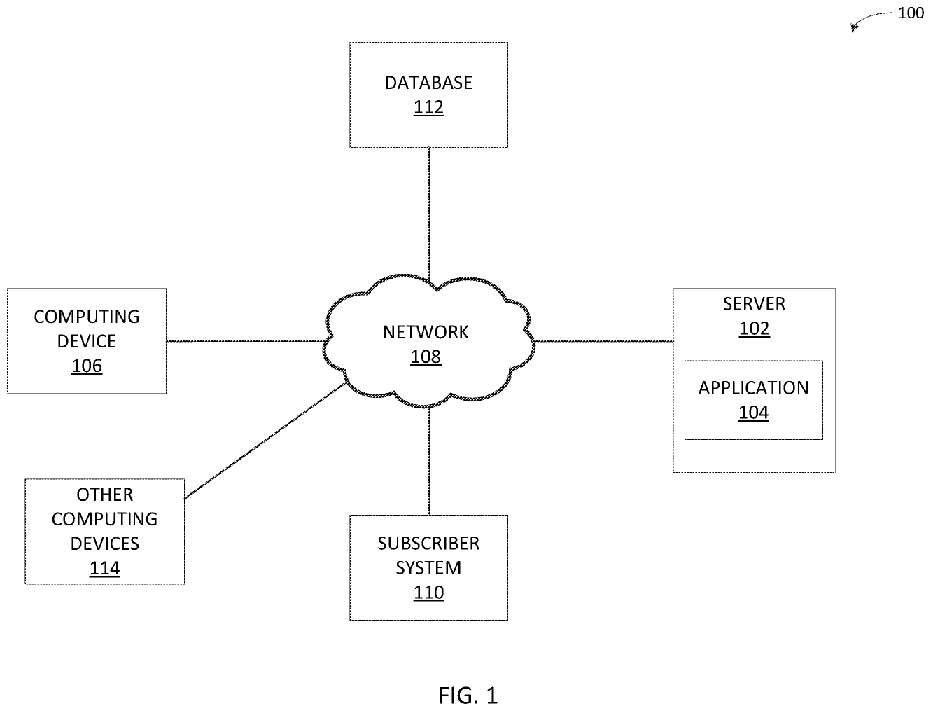

FIG. 1 depicts a computing environment 100 for identifying gaps in streaming data from a wearable device and filling in the gaps to generate a continuous data stream about an individual. As shown, the computing environment 100 includes a server 102, a computing device 106, a network 108, a subscriber system 110, a database 112, and other computing devices 114. Server 102 receives streaming data from a computing device 106 via network 108. The computing device 106 can include wearable devices, such as a smartwatch, heart rate monitor, activity tracker, smart glasses, smart clothes, and other devices worn by an individual capable of collecting data via sensor(s). The wearable device collects data about the individual wearing the wearable device, such as activity and health-related metrics (e.g., weight, temperature, step counts, calorie counts, pulse, heart rate). In some cases, the wearable device collects data about the individual's surrounding environment such as temperature, air pressure, and humidity. The network 108 includes, for example, a wireless LAN (WLAN), a wireless WAN (WWAN), 3G, 4G, LTE, and other types of networks capable of transmitting data between devices.

As depicted, the server 102 includes an application 104. The application 104 manages the data collected from the computing device 106. The application 104 identifies expected data segments are missing from the streaming data and fills in the missing data segments with data from other sources (e.g., data from other users, data previously collected about the individual, data from a predictive model). Estimated data is generated based on data from other sources, and the estimated data augments streaming data from the computing device106 to generate a continuous data stream. In some cases, the application 104 can publish a continuous data stream to a subscriber system 110. For example, the application 104 can publish the continuous data stream to an authorized subscriber (e.g., the subscriber system 110), including a medical professional, trainer, coach, and the individual from whom the data was collected from.

To identify expected data segments are missing, the application 104 may determine that the streaming data has stopped unexpectedly. In some cases, the application 104 can expect to receive streaming data due to previously collected data and can identify a gap when the streaming data is not received but is expected. In one example, if an individual wears a smart watch every day, the application 104 may expect to receive streaming data collected while the individual is wearing the smart watch. In this example, the application 104 can identify a gap when the individual forgets to wear the smart watch one day and does not receive the expected streaming data. In another example, if an individual wearing a smart watch goes running every day for 30 minutes, the application 104 can identify a gap in the streaming data received while the individual is running if the battery dies 10 minutes into the run and stops collecting data.

In other cases, the application 104 can expect to receive streaming data based on scheduled activities, such as calendar data, and can identify a gap when the streaming data is not received. The application 104 can identify scheduled activities on a calendar, from social media content, and other sources of information for determining the individual's scheduled activity. In one example, the application 104 may expect to receive streaming data when calendar data indicates a scheduled event on the individual's calendar is tagged as “exercise.” In such cases, the scheduled event tagged as “exercise” can be the first instance or a repeated instance on the individual's calendar. In this example, the application 104 can identify a gap when the individual forgets to wear the smartwatch and does not receive any expected streaming data, according to the calendar data.

To fill in a missing data segment, the application 104 retrieves at least one type of proxy data. For example, the application 104 may retrieve live streaming data from other computing devices 114, such as wearable devices worn by other users, previously collected data about the individual of the wearable device from database 112, or previously collected data about other users from the database 112. The application 104 retrieves as much proxy data as possible from multiple sources, if available, to determine metrics about the individual to complete gaps in a data stream that result from the computing device 106 not collecting expected sensor data, e.g., when a wearable device is not worn by the individual performing an activity.

In one embodiment, application 104 may generate estimated data about the individual with the proxy data adjusted according to the physical characteristics of the individual. For example, the application 104 can retrieve profile data about the individual, such as age, height, weight, and gender, and generate estimated data based on the proxy data and the profile data. With the estimated data, the application 104 fills in the gaps and augments the data collected from the wearable device to generate a continuous data stream. In some cases, the application 104 can publish the continuous data stream to a subscriber system 110 via the network 108. For example, the subscriber system 110 can be a computing device associated with an authorized subscriber, such as a medical professional, coach, trainer, or the individual. In such cases, the server 102 can publish the continuous data stream to a subscriber system 110 associated with a doctor who can use the continuous data stream to evaluate the health of the individual or make a diagnosis or decision impacting the health and well-being of the individual.

In some cases, the computing device 106 can perform one or more actions of the application 104, as described above, depending on the capabilities of the computing device 106.

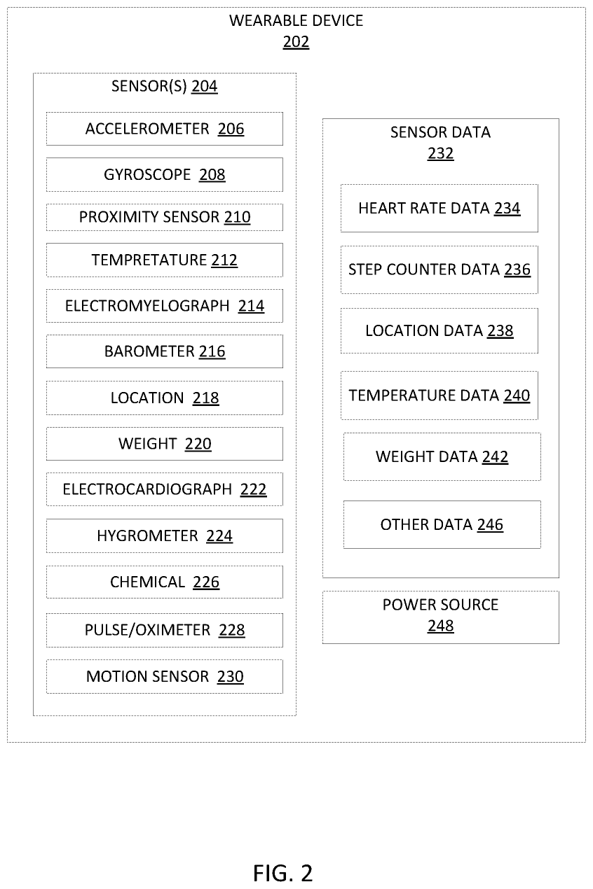

FIG. 2 is a diagram 200 illustrating a computing device capable of collecting data. As shown, the wearable device 202 includes a sensor 204, sensor data 232, and a power source 248. The power source 248 can provide power to the wearable device 202 allowing the sensor 204 to collect sensor data 232.

The sensor 204 includes, for example, an accelerometer 206, a gyroscope 208, a proximity sensor 210, a temperature sensor 212, an electromyleograph 214, a barometer 216, a location sensor 218, a weight sensor 220, an electrocardiograph 222, a hygrometer 224, a chemical sensor 226, a pulse oximeter 228, and motion sensor 230. The sensor 204 can collect sensor data 232 including metrics, such as heart rate data 234, step counter data 236, location data 238, temperature data 240, weight data 242, or other data 246 collected by sensor 204 indicative of a detected metric.

The accelerometer 206 collects acceleration data, such as direction and magnitude, about an individual wearing the wearable device 202. For example, the accelerometer 206 can collect data such as the speed and direction the individual is moving on a hiking trail.

The gyroscope 208 collects orientation data about the individual. In some cases, the gyroscope 208 can collect data about the orientation and stability of the individual. For example, the gyroscope 208 can collect data about the user's stability while hiking.

The proximity sensor 210 collects data about the presence of a nearby object, including other users, without requiring any physical contact with the object. In some cases, the proximity sensor 210 can emit an electromagnetic field (e.g., infrared light) and detect the presence of an object based on changes to the electromagnetic field emitted. For example, the proximity sensor 210 can detect whether other users are within ten feet of the individual when the individual is hiking. In another example, the proximity sensor 210 can detect whether other users are within five feet of the individual. Generally, the proximity sensor 210 can determine whether another object (including an individual and other users) is in proximity, such as within a threshold distance, to the proximity sensor 210.

The temperature sensor 212 collects temperature data 240. In some cases, the temperature sensor 212 can collect temperature data 240 about the individual, such as the individual's body temperature. In other cases, the temperature sensor 212 can collect temperature data 240 about the surrounding environment of the individual wearing the wearable device 202, such as the temperature of where the individual is hiking.

The electromyleograph 214 collects data about the electrical activity of the individual's muscle tissues. For example, the electromyleograph 214 can collect electrical activity data about the individual's muscle tissues when hiking.

The barometer 216 collects atmospheric data about the surrounding environment. In some cases, the barometer 216 can collect data about the atmospheric pressure in the surrounding environment and changes that occur over time. For example, the barometer 216 can collect data about the changing air pressure as an individual hikes up a mountain.

The location sensor 218 collects location data 238, such as the location of the individual wearing the wearable device 202. In some cases, the location sensor 218 can include a radio navigation-based system, such as terrestrial or satellite-based navigation systems. For example, satellite-based navigation systems can include a Global Positioning System (GPS), a Global Navigation Satellite System (GLONASS), Galileo, BeiDou Navigation Satellite System, and an Indian Regional Navigational Satellite System. In some cases, the location data 238 can collect longitude and latitude data. For example, the location sensor 218 can collect the GPS coordinates of a path of the individual hiking a mountain.

The weight sensor 220 collects weight data 242, such as the weight of the individual or the weight the individual is carrying. For example, the weight sensor 220 can collect weight data 242 about the individual and the backpack the individual is carrying while hiking. In another example, if an individual is weight training, the weight sensor 220 can collect weight data about the amount of weight the individual is lifting.

The electrocardiograph 222 collects heart rate data 234 about cardiac rhythm of an individual's heart. For example, the electrocardiograph 222 can collect data about the electrical activity of an individual's heart when exercising, at rest, or performing daily routine activities.

The hygrometer 224 collects data about the moisture content in the atmosphere. For example, the hygrometer 224 can collect data about the humidity in the surrounding atmosphere of the individual while hiking.

The chemical sensor 226 collects data about specific chemical substances. In some cases, the chemical sensor 226 can collect data about chemicals emitted by the individual in the form of sweat or exhalation indicative of the physical state of the individual's body. For example, the chemical sensor 226 can collect data about the electrolytes in an individual's sweat. In other cases, the chemical sensor 226 can collect data about chemicals that are present in the surrounding environment.

The pulse oximeter 228 collects data about the cardiac pulse and blood oxygen saturation of an individual. In some cases, the pulse oximeter 228 can collect data about the oxygen saturation of an individual for determining if the individual has average or too low blood oxygen levels.

The motion sensor 230 can collect data about the movement of an individual. In some cases, the motion sensor 230 can include a pedometer that can collect step counter data 236 about the number of steps an individual has walked.

Regardless of the type of sensors in the wearable device 202 or the type of data collected, the wearable device 202 collects data when properly configured and worn by an individual (e.g., metrics such as heart rate data 234, pulse rate, step counter data), and in some cases, the surrounding environment (e.g., metrics such as temperature data 240, air pressure data, humidity). Data collected by the wearable device 202 includes the metric data recorded by the sensor and temporal data regarding when the metric was recorded, such as a time stamp. Further, data collected by the wearable device 202 can also be used to determine additional metrics. For example, the wearable device 202 can generate metrics about amount of calories burned by the individual based on the step counter data 236 and heart rate data 234.

In one embodiment, data collected by the sensor 204 is transmitted to other computing devices. As noted, such data frequently includes gaps for when the wearable device 202 fails to collect data, such as when the individual forgets to wear the wearable device 202 or the wearable device 202 malfunctions. In some cases, the wearable device 202 transmits the collected data without identifying any gaps. In other cases, the wearable device 202 is “smart” enough to identify missing data and transmit the indication of missing data.

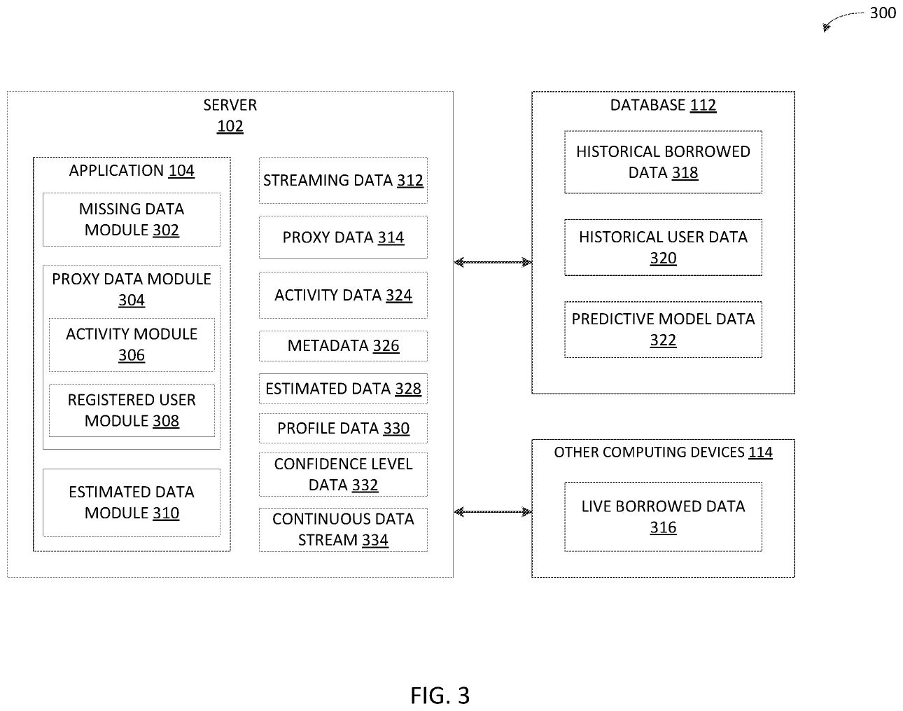

FIG. 3 depicts a view 300 of a server 102, a database 112, and other computing devices 114. The server 102, via the application 104, evaluates data collected from a computing device, such as a wearable device, to identify expected data segments are missing, retrieves proxy data from at least other computing devices 114 or a database 112, generates estimated data, and fills in gaps with the estimated data.

As shown, the application 104 includes a missing data module 302, a proxy data module 304, and an estimated data module 310. The missing data module 302 may identify expected data segments are missing from the streaming data 312 received from a wearable device are missing based on different types of indications received by the missing data module 302. In some cases, the missing data module 302 identifies expected data segments are missing based on an indication that the wearable device is not collecting data. For example, if an individual normally pairs a smart watch (e.g., wearable device) and a smart phone (e.g., computing device), the missing data module 302 can receive an indication from the smart phone that the smart watch is not currently paired with the smart phone carried by the individual, and in turn, not collecting expected data. In another example, the missing data module 302 can request a pairing indication from a computing device and receive an indication that the wearable device is not currently in the pairing environment with the computing device.

In other cases, the missing data module 302 can receive an indication from the wearable device that data is missing from an otherwise continuous dataset. In still other cases, the missing data module 302 can analyze historical user data 320 and determine whether expected data is present. For example, the missing data module 302 can determine a pattern of activity from the historical user data 320 that an individual wears a wearable device every day, and in the case where an individual forgets to wear the wearable device, the missing data module 302 can determine based on the pattern that there is missing data when such data is expected.

The proxy data module 304 includes an activity module 306 and a registered user module 308. Together, the activity module 306 and the registered user module 308 determine which type of proxy data 314 the proxy data module 304 retrieves to use in a particular instance. Proxy data 314 generally refers to data from a variety of sources that may be used to complete gaps in the streaming data 312. Typically, proxy data 314 is selected to be representative of an individual relative to a gap in sensor data collected for that individual and as many types of proxy data 314 are retrieved as possible. In some cases, proxy data 314 includes data borrowed from other users. For example, proxy data 314 includes live borrowed data 316 from other computing devices 114, such as wearable devices worn by other users, or data previously collected from wearable devices of other users, such as historical borrowed data 318 stored on the database 112. In other cases, proxy data 314 includes data previously collected from the individual's wearable device, such as historical user data 320. In still yet other cases, proxy data 314 includes data from a predictive or analytical model of activity, such as predictive model data 322.

To determine which one or more types of proxy data to retrieve, the activity module 306 determines the activity the individual is performing during the gaps in the streaming data 312. In particular, activity module 306 retrieves the activity data 324 associated with the individual. For example, the activity module 306 may access the individual's calendar, social media content, or other sources of information to determine the individual's scheduled activity during a given gap identified in the streaming data. For example, the activity module 306 could determine from calendar data that the individual is scheduled to hike with friends during the time period that corresponds to a missing data segment expected in the streaming data.

In some cases, the activity module 306 can also confirm the individual is performing the scheduled activity by accessing metadata 326 associated with the individual. In some cases, the metadata 326 can be retrieved from a computing device that is paired to the wearable device. For example, if an individual has a smart watch paired with a smart phone and the individual forgets to wear the smart watch, the activity module 306 can confirm the location of the individual by requesting the GPS coordinates of the smart phone. Based on the received GPS coordinates, the activity module 306 can determine the individual is where they are supposed to be. Further, based on the individual's location, the activity module 306 determines the individual is taking part in the scheduled activity.

In one embodiment, the registered user module 308 determines whether the proxy data module 304 can retrieve data from other users (e.g., live borrowed data 316 or historical borrowed data 318). Based on the activity data 324, the registered user module 308 determines if there are registered users who have consented to allow the application 104 to borrow data. Further, the registered user module 308 may identify registered users to borrow live data from based on the similarities between the registered user and the individual. For example, the registered user module 308 may evaluate characteristics such as physical similarities, activity being performed, or location. For example, the registered user module 308 can determine that a registered user is located near the individual and performing a same activity as expected by the activity module 306 of the individual. In such cases, the registered user module 308 can borrow live data (e.g., live borrowed data 316) from the wearable device of the registered user. In another example, the registered user module 308 can identify a registered user is a parallel person because the registered user is located near the individual, performing the same activity as expected of the individual, and shares at least one physical characteristic in common with the individual (e.g., the registered user and the individual are of the same gender and have the same or are within a designated height, weight, or age range). In such cases, the registered user module 308 can borrow live data from the wearable device of the parallel person.

In some cases, the registered user module 308 can determine that live data is available from multiple registered users. In such cases, the registered user module 308 could identify registered users that are similar to the individual based on profile data 330, e.g., gender, age, height, weight, current activity. The registered user module 308 could further designate a particular registered user as a source to borrow live data from. For example, if an individual is a female, 25 years old, 5 feet and 8 inches tall, weighing 130 pounds, and hiking up a mountain in California, the registered user module 308 can determine that of the multiple registered users available to retrieve live data from, the registered user that is female, 25 years old, 5 feet and 5 inches tall, weighing 120 pounds, and hiking up the same mountain in California is better to retrieve live streaming data from than a male, 34 years old, 6 feet and 2 inches tall, weighing 165 pounds, and skiing down a mountain in Colorado. Further still, the registered user module 308 can identify and designate the female registered user as the parallel person to borrow data from for the individual while the individual is hiking.

In other cases, the registered user module 308 can retrieve historical borrowed data 318, based on a determination by the registered user module 308 that there is no live borrowed data 316 available to borrow as proxy data 314 from other computing devices 114. The registered user module 308 retrieves historical borrowed data 318 of other users from the database 112 based on the activity the individual is performing. Further, in some cases, the registered user module 308 can retrieve historical borrowed data 318 based on one or more physical similarities of other users to the individual, such as same gender and within a designated range of (or same) age, height, or weight.

In still other cases, the proxy data module 304 can retrieve previously collected user data (e.g., historical user data 320) or data from a predictive model as proxy data 314 based on what activity the individual is performing.

The estimated data module 310 generates estimated data 328 representative of the data that would have been collected by the wearable device had the gap identified in the streaming data not existed. The estimated data module 310 generates estimated data based on the proxy data 314 retrieved by the proxy data module 304 and retrieving profile data 330. The estimated data module 310 adjusts the proxy data 314 according to the physical characteristics of the individual from profile data 330 to estimate data that would have otherwise been collected by the wearable device.

In some cases, the estimated data module 310 can determine, based on a registered user (e.g., a parallel person) walking 2,402 steps with the individual having a comparable weight, height, and gender to the individual that had the individual been wearing the wearable device when hiking would walk an estimated 2,402 steps. In other cases, the estimated data module 310 can determine, based on a registered user (e.g., not a parallel person) walking with the individual having a different weight, height, and gender, that had the individual been wearing the wearable device when hiking would have walked an estimated 2,450 steps.

Further, in some cases, the estimated data module 310 can also generate confidence level data 332 that indicates a predicted measure of how accurate the estimated data 328 is in completing the streaming data 312. For example, based on the registered user and the individual having the same or similar physical build and performing the same or similar activity, a higher confidence level is assigned to the estimated data generated. In comparison, if the registered user and individual are performing the same activity but have different physical build, then the confidence level assigned to the estimated data is lower.

With the estimated data 328, the application 104 can generate a continuous data stream 334 by filling in the gaps. Further, if generated by the application 104, the subscriber system may receive confidence level data 332 along with the continuous data stream 334.

In some embodiments, the application 104 continues to retrieve proxy data 314 and generate estimated data 328 to fill in the identified gaps until the wearable device begins providing streaming data. For example, the individual can wear the device again, replace a battery in the wearable device, or other such events in which the server can start receiving streaming data from the wearable device.

In other embodiments, the application 104 can update the continuous data stream 334 published to a subscriber system based on data received by the server 102 after the estimated data is generated. For example, an individual can go hiking with three friends, and the server retrieves proxy data from two of the three friends because the third friend's wearable device is not synced up with the server 102. When the wearable device of the third friend is synced, the server 102 can retrieve sensor data collected by the third friend's wearable device and update the estimated data generated. With the updated estimated data, the server 102 can publish an updated continuous data stream to the subscriber system.

In other cases, actions performed by server 102 and application 104 may be performed at the wearable device (not depicted).

The database 112 stores data collected from wearable devices and other computing devices 114. For example, the database 112 can store live streaming data 312 from a wearable device of the individual as historical user data 320 after the live streaming data 312 is received by the server 102. In another example, the live borrowed data 316 is stored as historical borrowed data 318.

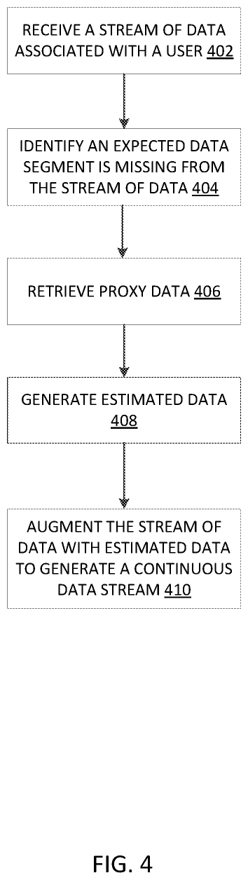

FIG. 4 depicts a method 400 for generating a continuous data stream by identifying expected data segments are missing from streaming data collected by a computing device, such as a wearable device, and retrieving proxy data to generate estimated data that is used to augment the streaming data and generate a continuous data stream, according to one embodiment.

As shown, the method 400 begins at step 402 where a server receives a stream of data associated with a user. In some cases, the stream of data is captured by a wearable device with biometric sensors. For example, a server may receive heart rate data from a heart monitor sensor (e.g., electrocardiograph) on a smart watch and a set of time stamps indicating when the heart monitor sensor recorded the heart rate data.

At step 404, the server identifies expected data segments are missing from the streaming data. In one example, a smart watch is paired with a smart phone carried by the individual. In this example, if the individual forgets to wear the smart watch, the server can identify expected data is missing because the smart watch is not currently part of the pairing environment and the individual is performing scheduled activities based on the location of the individual's smart phone. In another example, the server can identify missing data segments in streaming data from a wearable device based on not receiving expected data according to previously collected data or calendared activities.

At step 406, the server retrieves proxy data. For example, the server determines a registered user that has consented to share data is performing the same activity as the individual. In some cases, the server identifies a registered user as a parallel person because the registered user has one or more similar physical characteristics in common with the individual and is performing the same or similar activity. The server retrieves live streaming data from the wearable device of the parallel person, including heart rate data, and adjusts the live streaming data, as described at step 408, to generate estimated data. In other cases, the server identifies a registered user performing the same or similar activity as the individual but not sharing any physical characteristics. In such case, the server retrieves the live streaming data from the wearable device of the registered user and adjusts the live streaming data, as described at step 408, to generate estimated data.

At step 408, the server generates estimated data based on the proxy data retrieved and physical characteristics of the individual. For example, based on the retrieved proxy data and physical characteristics of the individual, the server generates estimated data specific for the individual. The server then uses the estimated data to fill in the missing heart rate data from the streaming data. In some cases, the server generates estimated data by adjusting live streaming data retrieved from the wearable device of a registered user to account for any physical characteristic differences between the registered user (including the parallel user) and the individual. In other cases, the server extrapolates metrics from the live streaming data retrieved from the wearable device of a parallel person to generate estimated data.

At step 410, the server augments the streaming data with the estimated data to generate a continuous data stream. As described, the server may complete a gap of the heart rate data in the streaming data using the estimated data generated at step 408.

In one embodiment (not depicted), the server can publish the continuous data stream to a subscriber system. For example, the server publishes the continuous data stream of the individual's heart rate data to the individual's doctor. In another example, the server publishes the continuous data stream and grants access to the continuous data stream to authorized subscribers, including medical professionals, coaches, trainers, and the individual.

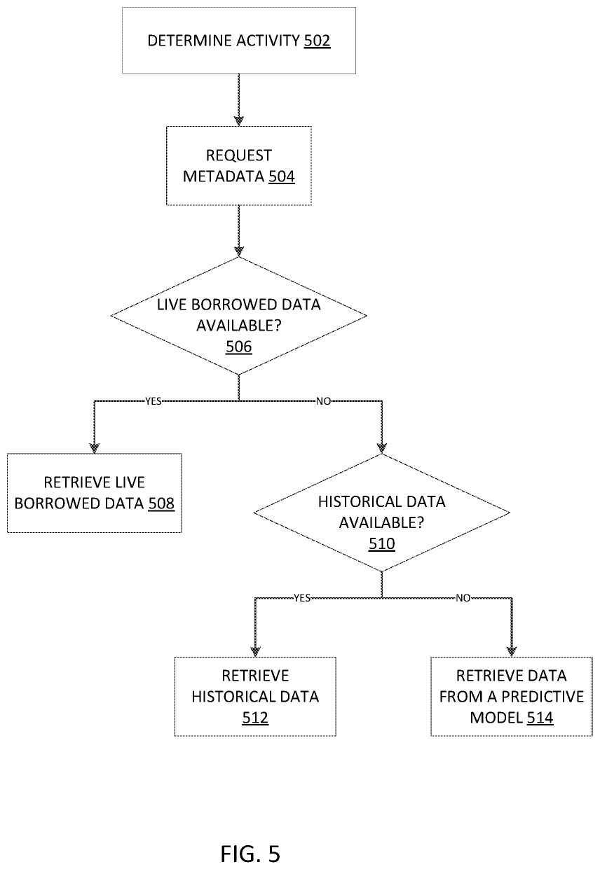

FIG. 5 depicts a method 500 for determining which type of proxy data to retrieve to generate estimated data.

As shown, the method 500 begins at step 502 where a server determines the individual's expected activity, as described in detail in FIG. 3. In some cases, the server accesses an individual's calendar to determine from calendar data the individual's expected activity during the gap in the streaming data. For example, the server can access an individual's calendar and determine that corresponding to the time of the missing data the individual is expected to be hiking. In other cases, the server can access other activity tracking sources such as social media to determine the individual's expected activity. Further, in some cases, the server can access previously collected data about the individual to determine a history or pattern in such data about the individual to determine the individual's expected activity.

In some cases, the server requests metadata to confirm the individual is performing the expected activity (step 504). For example, the server could retrieve location metadata from a smart phone that is paired with the smart watch but is not currently part of the pairing environment because the individual forgot to wear the smart watch. Based on the location metadata, the server can confirm the location of the individual (e.g., at the park) to determine that the individual is performing the expected activity.

At step 506, the server determines whether live streaming data is available from other users to borrow as proxy data. If live data is available from other registered users, then at step 508, the server retrieves the live data as proxy data. For example, if there is a registered user in close proximity to the individual, performing the same activity the individual is expected to perform (e.g., hiking), then the server can retrieve data collected from the registered user's wearable device. The proximity of the registered user and the individual could be based on the location metadata associated with the individual. Alternatively, the proximity of the registered user and the individual could also be based on proximity sensor data from the wearable device of the registered user or the individual indicating whether an object (e.g., the registered user or the individual) is within a proximity distance detected by the proximity sensor. For example, if the individual is wearing a smart watch that has a functional proximity sensor, even though the other sensors are not collecting sensor data, then the proximity sensor data from the individual's wearable device can be used to determine whether the registered user and the individual are in proximity to each other.

If the server determines live data from other users is not available, then at step 510, the server determines whether historical data is available. If historical data associated with the individual or other users is available, then at step 512, the server retrieves previously collected data from the individual or other users as proxy data. For example, if the individual has previously gone hiking on the same path every week for the past 3 months, then the server can retrieve the individual's data previously collected during the previous hikes. In another example, if the individual is hiking for the first time, then the server can retrieve data previously collected from other users who have previously hiked at the same path. In other cases, the server can retrieve historical data from the individual and other users as proxy data. In still other cases, the server can retrieve live data from other wearable devices and previously collected data.

If the server determines there is no historical data available, then at step 514, the server retrieves proxy data from a predictive model indicative of what metrics the wearable device would have collected in the gaps of streaming data.

Generally, the type of proxy data the server retrieves is based on availability of the types of proxy data in a particular case. For example, the server can retrieve only live streaming data if no other type of proxy data is available. In another example, the server can retrieve, as is available, live streaming data, borrowed data, and data from a predictive model.

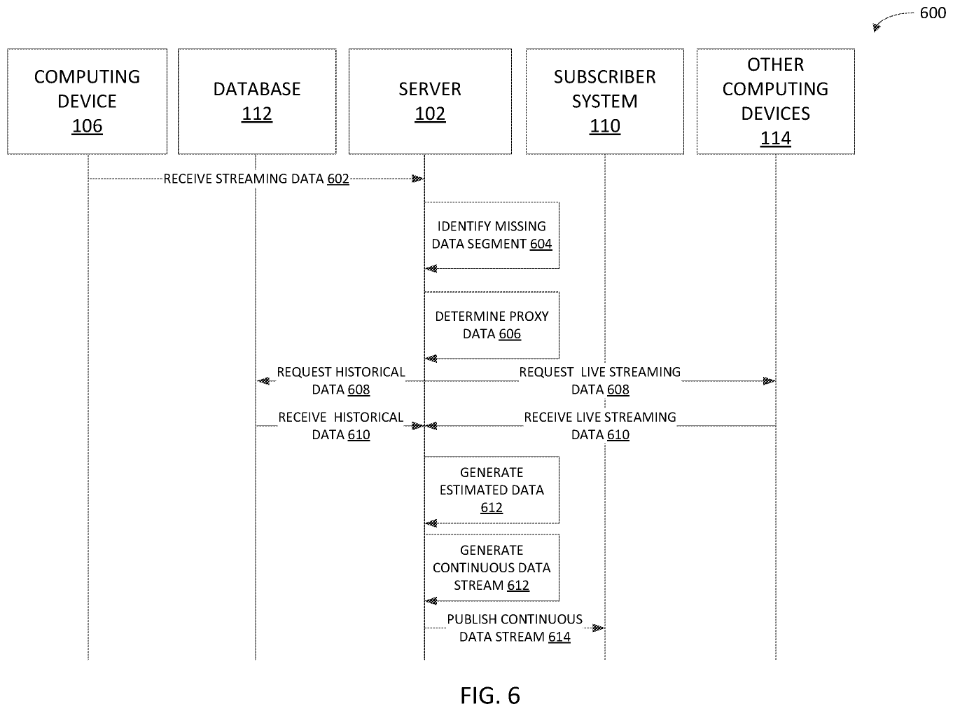

FIG. 6 illustrates a method 600 for identifying gaps in streaming data, generating estimated data to fill in the gaps, and augmenting the streaming data with the estimated data to generate a continuous data stream. As shown, the server 102 receives 602 streaming data associated with an individual from a computing device 106, such as a wearable device. For example, the server receives step counts from a fitness tracker. The server 102 identifies 604 an expected data segment is missing from a streaming data. For example, the server receives an indication from the fitness tracker that expected step counts data is missing. The server 102 determines 606 a type of proxy data to retrieve. In some cases, the server determines retrieving live data, previously collected data, or both. As depicted, the server 102 can request 608 proxy data (e.g., live streaming data and historical data) from multiple sources, including other computing devices 114, such as wearable devices worn by other users, and database 112. Based on the request 608, the server 102 can receive 610 proxy data (e.g., live streaming data and historical data) from other computing devices 114 and the database 112, respectively. In some cases, the server 102 can retrieve data from a predictive model (not depicted), based on the availability of the types of proxy data.

The server 102 generates 612 estimated data based on the retrieved proxy data. For example, with the proxy data, the server determines the number of steps an individual would have walked had the individual worn the fitness tracker. With the estimated data, the server fills in the gaps and generates a continuous data stream. For example, the server can generate a continuous data stream of step counts for the individual, even though the individual was not wearing the fitness tracker when walking. As illustrated, the server 102 can publish 614 the continuous data stream to a subscriber system 110, such as a medical professional. For example, the server can publish the continuous data stream to the individual's trainer. In another example, the server can publish the continuous data stream and allow authorized subscribers to access the continuous data stream.

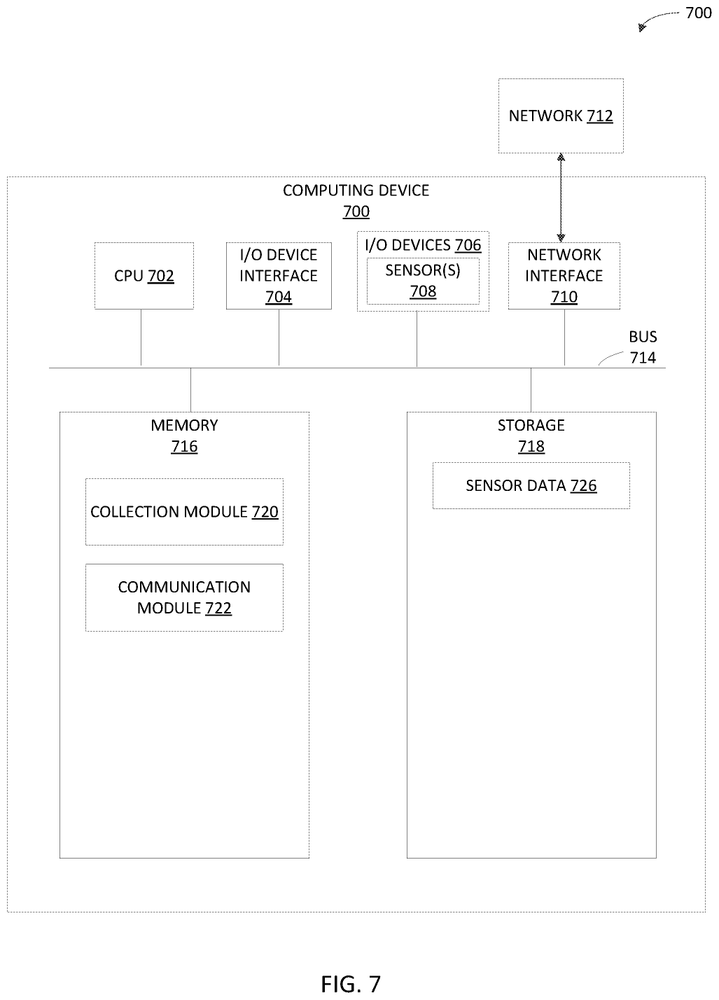

FIG. 7 depicts a computing device 700 configured with sensors to collect data, according to one embodiment of the present disclosure.

As illustrated, the computing device 700 includes a CPU 702 connected to a data bus 714. CPU 702 is configured to process computer-executable instructions, e.g., stored in memory 716 or storage 718, and to cause computing device 700 to perform methods described herein, including collecting sensor data when the individual is wearing the device. CPU 702 is included to be representative of a single CPU, multiple CPUs, a single CPU having multiple processing cores, and other forms of processing architecture capable of executing computer-executable instructions.

The computing device 700 further includes input/output (I/O) device interface 704, which allows the computing device 700 to interface with I/O devices 706, including sensors 708, as described in further detail in FIG. 2. Note that while not depicted with independent external I/O devices 706, computing device 700 can connect with external I/O devices 706 through physical and wireless connections.

The computing device 700 further includes network interface 710, which provides computing device 700 with access to external networks 712 and thereby external computing devices, such as server 102 described in further detail FIGS. 1 and 3.

The computing device 700 further includes memory 716. For example, memory 716 can be representative of random access memory. As depicted, memory 716 includes a collection module 720 and a communication module 722. Note that while shown as a single memory 716 in FIG. 7 for simplicity, the various aspects stored in memory 716 can be stored in different memories, but all accessible by CPU 702.

The collection module 720 collects sensor data 726 from sensors 708. In some cases, the collection module 720 collects sensor data 726 upon input from an individual to the wearable device to collect data. For example, the individual can wear the wearable device, signaling to collect sensor data 726.

In some embodiments, the collection module 720 can identify missing sensor data. For example, the collection module 720 can determine a sensor 708 is not collecting expected sensor data 726 based on a scheduled activity or previously collected data about the individual. In turn, the collection module 720 can determine there is missing data because the sensor 708 is not collecting expected sensor data. In one example, if a heart rate sensor is not collecting expected data in a wearable device worn by an individual but is collecting expected step counts from a pedometer on the wearable device, then the collection module 720 can identify expected heart rate data is missing because an individual walking with no heart rate is impossible. In another example, the collection module 720 can identify expected sensor data is missing if the individual is scheduled to hike at a park and the location metadata indicates the individual is at the park but no sensor data is received from the individual's wearable device (e.g., the individual forgot to wear the wearable device or the wearable device has malfunctioned and is not collecting sensor data as expected).

The communication module 722 transmits the sensor data 726 collected by the collection module via the network 712. For example, the metrics detected by the sensor 708 can be transmitted as streaming data to a server.

In some embodiments, the computing device 700 can further generate estimated data from proxy data and fill in the missing data segments to augment the data collected by the computing device 700 with the estimated data and generate a continuous data stream.

As shown, computing device 700 includes storage 718 storing sensor data 726. As with memory 716, a single storage 718 is depicted in FIG. 7 for simplicity, but the various aspects stored in storage 718 may be stored in different storages, but all accessible by CPU 702 via internal connections, such as bus 714, or external connection, such as network interface 710.

Although shown as a single unit, storage 718 may be a combination of fixed and/or removable storage devices, such as fixed disc drives, removable memory cards, optical storage, or SSD or flash memory devices. In some cases, the computing device 700 does not have a separate memory 716 and storage 718.

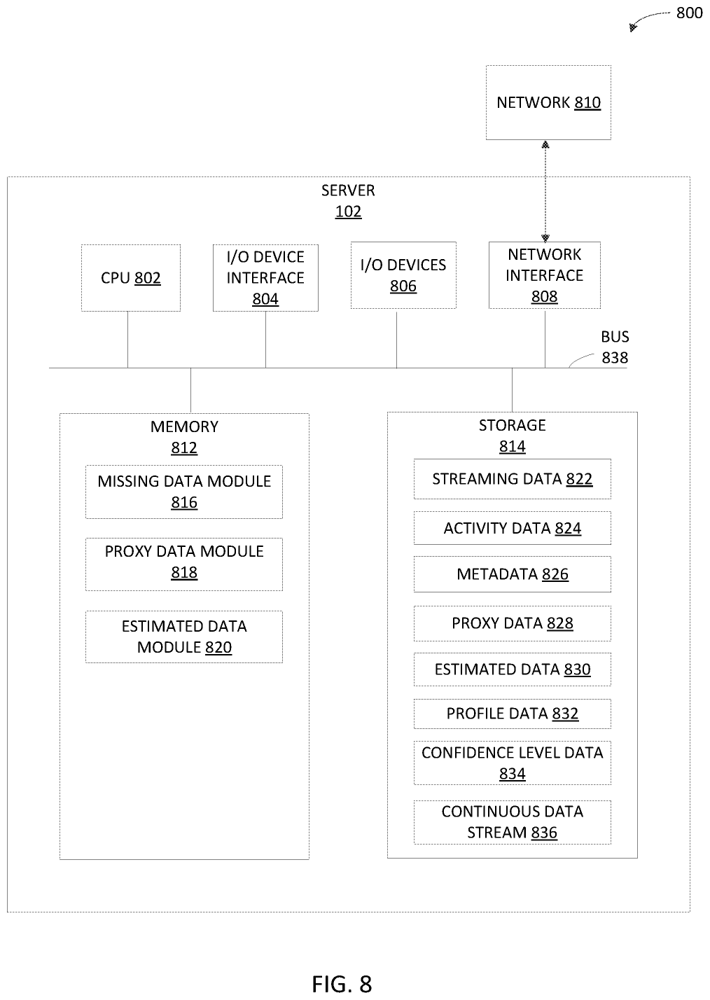

FIG. 8 depicts a server 800 configured to identify missing data segments and generate estimated data to fill in the gaps.

As illustrated, the server 102 includes a CPU 802 connected to a data bus 838. CPU 802 is configured to process computer-executable instructions, e.g., stored in memory 812 or storage 814, and to cause server 102 to perform methods described herein in FIGS. 3-6. CPU 802 is included to be representative of a single CPU, multiple CPUs, a single CPU having multiple processing cores, and other forms of processing architecture capable of executing computer-executable instructions.

Server 102 further includes input/output (I/O) device interface 804, which allows the server 102 to interface with I/O devices 806, such as keyboards, mouse devices, pen input, and other devices that allow for interaction with server 102. Note that while not depicted with independent external I/O devices 806, server 102 can connect with external I/O devices 706 through physical and wireless connections.

Server 102 further includes network interface 808, which allows the server 102 to communicate with other devices via network 810, such as a computing device (e.g., wearable device), as described in further detail FIGS. 1 and 3.

Server 102 further includes memory 812. As depicted, memory 812 includes missing data module 816, proxy data module 818, and estimated data module 820, as described in detail in FIG. 3. Note that while shown as a single memory 812 in FIG. 8 for simplicity, the various aspects stored in memory 812 can be stored in different memories, but all accessible by CPU 802.

Server 102 further includes storage 814, which in the example depicted can store streaming data 822, activity data 824, metadata 826, proxy data 828, estimated data 830, profile data 832, confidence level data 834, and continuous data stream 836. As with memory 812, a single storage 814 is depicted in FIG. 8 for simplicity, but the various aspects stored in storage 814 may be stored in different storages, but all accessible by CPU 802 via internal connections, such as data bus 838, or external connection, such as network interface 808. Although shown as a single unit, storage 814 may be a combination of fixed and/or removable storage devices, such as fixed disc drives, removable memory cards, optical storage, SSD or flash memory devices, network attached storage (NAS), or connections to a storage area-network (SAN) devices.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet.

In context of the present invention, a computing device (e.g., a wearable device worn by an individual) captures streaming sensor data. The collected sensor data is stored in a cloud storage location where the streaming sensor data can be accessed by cloud-based systems or servers to identify gaps in the streaming sensor data of expected data, retrieve proxy data from cloud computing resources, and generate estimated data based on the proxy data to fill in the gaps in the streaming sensor data to generate a continuous data stream. Further, the subscriber systems that are part of the cloud can receive the continuous data stream.

While the foregoing is directed to embodiments of the present invention, other and further embodiments of the invention may be devised without departing from the basic scope thereof, and the scope thereof is determined by the claims that follow.

What is claimed is:

1. A method for generating a continuous data stream, the method comprising:
receiving a stream of data associated with a first user, wherein the stream of data includes:
a metric, and
a time stamp indicating when the metric is recorded;
identifying an expected data segment is missing from the stream of data;
retrieving at least one type of proxy data;
generating estimated data based on the at least one type of proxy data; and
augmenting the stream of data with the estimated data to generate a continuous data stream.

2. The method of claim 1, wherein the stream of data associated with the first user is captured by a first wearable device worn by the first user.

3. The method of claim 2, wherein identifying the expected data segment is missing from the stream of data comprises at least one of:
receiving a first type of indication from the first wearable device that data is missing from the stream of data;
receiving a second type of indication from a computing device paired to the first wearable device that the first wearable device is not in a pairing environment; or
determining the expected data segment is missing based on expected activity of the first user.

4. The method of claim 2, wherein retrieving the at least one type of proxy data comprises:
identifying an expected activity of the first user; and
confirming the first user is performing the expected activity based on location metadata from a computing device of the first user.

5. The method of claim 4, wherein identifying the expected activity of the first user comprises at least one of:
accessing calendar data associated with the first user to identify a scheduled activity; or
determining a pattern of activity based on data previously collected from the first wearable device.

6. The method of claim 4, further comprising:
retrieving live streaming data from a second wearable device worn by a second user comprises:
determining the second user is in proximity to the first user;
determining the second user is performing a same activity as the first user; or
determining the second user is physically similar to the first user.

7. The method of claim 4, further comprising:
retrieving, based on availability, at least one of:
data previously collected from the first wearable device,
data previously collected from a second wearable device, or
data from a predictive model.

8. The method of claim 1, further comprising:
publishing the continuous data stream to a subscriber.

9. The method of claim 1, wherein generating the estimated data comprises:
retrieving a characteristic of the first user comprising at least one of:
age,
gender,
height, and
weight; and
adjusting the at least one type of retrieved proxy data based on the characteristic of the first user.

10. A system, comprising:
a processor; and
a memory storing instructions which when executed by the processor perform a method for generating a continuous data stream, the method comprising:
receiving a stream of data associated with a first user, wherein the stream of data includes:
a metric, and
a time stamp indicating when the metric is recorded,
identifying an expected data segment is missing from the stream of data,
retrieving at least one type of proxy data,
generating estimated data based on the at least one type of proxy data, and
augmenting the stream of data with the estimated data to generate the continuous data stream.

11. The system of claim 10, wherein the stream of data associated with the first user is captured by a first wearable device worn by the first user.

12. The system of claim 11, wherein retrieving the at least one type of proxy data comprises:
identifying an expected activity of the first user; and
confirming the first user is performing the expected activity based on location metadata from a computing device of the first user.

13. The system of claim 12, wherein identifying the expected activity of the first user comprises at least one of:
accessing calendar data associated with the first user to identify a scheduled activity; or
determining a pattern of activity based on data previously collected from the first wearable device.

14. The system of claim 12, further comprising:
retrieving live streaming data from a second wearable device worn by a second user comprises:
determining the second user is in proximity to the first user;
determining the second user is performing a same activity as the first user; or
determining the second user is physically similar to the first user.

15. The system of claim 12, further comprising:
retrieving, based on availability, at least one of:
data previously collected from the first wearable device,
data previously collected from a second wearable device, or
data from a predictive model.

16. A computer program product for a method of generating a continuous data stream, the computer program product comprising:
a computer-readable storage medium having computer-readable program code embodied therewith, the computer-readable program code executable by one or more computer processors to:
receive a stream of data associated with a first user, wherein the stream of data includes:
a metric, and
a time stamp indicating when the metric is recorded,
identify an expected data segment is missing from the stream of data,
retrieve at least one type of proxy data,
generate estimated data based on the at least one type of proxy data, and
augment the stream of data with the estimated data to generate a continuous data stream.

17. The computer program product of claim 16, wherein the stream of data associated with the first user is captured by a first wearable device worn by the first user.

18. The computer program product of claim 17, wherein retrieval of the at least one type of proxy data comprises:
identifying an expected activity of the first user; and
confirming the first user is performing the expected activity based on location metadata from a computing device of the first user that is paired with the first wearable device.

19. The computer program product of claim 18, further comprising:
retrieving live streaming data from a second wearable device worn by a second user comprises:
determining the second user is in proximity to the first user;
determining the second user is performing a same activity as the first user; or
determining the second user is physically similar to the first user.

20. The computer program product of claim 18, wherein identifying the expected activity of the first user comprises at least one of:
accessing calendar data associated with the first user to identify a scheduled activity; or
determining a pattern of activity based on data previously collected from the first wearable device.
